(19) United States
(12) Patent Application Publication
(10) Pub. No.: US 2026/0179233 A1
(43) Pub. Date: Jun. 25, 2026

(54) CONTINUOUS SCENE FLOW ESTIMATION SYSTEMS AND METHODS

(71) Applicant: QUALCOMM Incorporated, San Diego, CA (US)

(72) Inventors: Rahul Ahuja, San Diego, CA (US); Varun Ravi Kumar, San Diego, CA (US); Senthil Kumar Yogamani, San Diego, CA (US)

(21) Appl. No.: 18/999,812

(22) Filed: Dec. 23, 2024

(51) Int. Cl. G06T 7/246

(52) U.S. Cl. CPC G06T 7/246; G06T 2207/10016; G06T 2207/10028; G06T 2207/20084; G06T 2207/30252

(57) ABSTRACT

This disclosure provides systems, methods, and devices for vehicle driving assistance systems that support image processing. In a first aspect, a method of image processing includes receiving point cloud data comprising a sequence of a plurality of point clouds with respect to time; determining, for a first point cloud, a first set of patches; determining, for the first point cloud, a second set of patches having patches of a different size than patches of the first set; determining a latent representation of the point cloud data and of motion across the sequence of the plurality of point clouds based on the first and second sets of patches and a second point cloud; and determining a scene flow representing the motion depicted across the sequence of the plurality of point clouds based on the latent representation. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### Introduction

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection. Various driving, or movement, assistance systems have also been produced in machine automation generally, such as in robotics.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road. Aspects of this disclosure also provide improved systems for assisting users of non-vehicle systems such as robotics.

Example embodiments may improve autonomous driving systems through improved three-dimensional motion detection, although aspects of the motion detection processing described herein may also be applied to other applications, such as motion detection on camera systems, including camera systems on mobile phones, or such as other machine control-assistance systems or automation systems generally. Motion detection techniques may be used to detect motion of one or more objects in a scene. For example, motion detection can be used to detect or identify motion of markings in an environment. Examples of fields where a device may determine motion of markings include autonomous driving by autonomous driving systems (e.g., of autonomous vehicles), autonomous navigation by a robotic system (e.g., an automated vacuum cleaner, an automated surgical device, etc.), among others. For instance, a three-dimensional (3D) environment may include markings that actively move through the environment, such as vehicles. It can be important for the autonomous device to detect such markings and accurately navigate the space relative to such markings.

Example embodiments provide methods for predicting scene flow of an environment surrounding a vehicle. Scene flow estimation provides detailed motion analysis of every object in a vehicle's vicinity, and unlike optical flow which only captures movement in two dimensions, scene flow estimation captures movement in three dimensions, thereby enabling the precise detection of object trajectories and velocities. Scene flow computes motion (e.g., flow) vectors based on at least two point clouds for points or groups of points in the at least two point clouds, thus capturing the movement of points in the point clouds. A flow vector represents the motion of a point or group of points from one point cloud to the next, and can include a horizontal displacement component (e.g., along the x-axis), a vertical displacement component (e.g., along the y-axis), and a depth displacement component (e.g., along the z-axis). A collection of flow vectors associated with a collection of points or groups of points is the scene flow, which represents the three-dimensional motion of a scene. In some embodiments, scene flow can be computed with image depth data rather than point cloud data.

Scene flow can be continuous or discrete. Continuous scene flow is based on a function that can output scene flow (e.g., a vector difference) at any intermediate time point between two time stamps. For example, when one point cloud has a time stamp of 0 seconds and a second point cloud has a time stamp of 1 second, the continuous scene flow function can output scene flow at 0.5 seconds. Conversely, discrete scene flow can output scene flow only between the two time stamps themselves. For example, discrete scene flow can only output scene flow between the point cloud at 0 seconds and the point cloud at 1 second.

Example methods for predicting scene flow include a multi-head attention mechanism that includes, as heads, dedicated self-attention mechanisms for different-sized patches of point cloud data representing a scene. For example, point cloud data of an input video frame may be divided into 4×4 patches that are provided to a first self-attention mechanism and may also be divided into 8×8 patches that are provided to a second self-attention mechanism. The multi-head attention mechanism outputs a latent representation of the scene and the scene's motion. The latent representation is then used to model the scene flow of the scene. For example, the latent representation may be input to a neural ordinary differential equations (ODE) machine learning model which outputs a representation (e.g., a continuous function) of the scene flow.

In one aspect of the disclosure, a method for determining scene flow includes receiving point cloud data including a sequence of a plurality of point clouds with respect to time. The sequence of the plurality of point clouds includes a first point cloud and a second point cloud. The method further includes determining, for the first point cloud, a first set of patches. Each patch of the first set of patches is of a first size and associated with a respective portion of the first point cloud The method further includes determining, for the first point cloud, a second set of patches. Each patch of the second set of patches is of a second size different than the first size and associated with a respective portion of the first point cloud. A latent representation of the point cloud data and of motion across the sequence of the plurality of point clouds is thereafter determined based on the first and second sets of patches and the second point cloud. A scene flow representing the motion depicted across the sequence of the plurality of point clouds is then determined based on the latent representation.

In an additional aspect of the disclosure, an apparatus includes at least one processor and a memory coupled to the at least one processor. The at least one processor is configured to perform operations including receiving point cloud data including a sequence of a plurality of point clouds with respect to time. The sequence of the plurality of point clouds includes a first point cloud and a second point cloud. The operations further include determining, for the first point cloud, a first set of patches. Each patch of the first set of patches is of a first size and associated with a respective portion of the first point cloud The operations further include determining, for the first point cloud, a second set of patches. Each patch of the second set of patches is of a second size different than the first size and associated with a respective portion of the first point cloud. A latent representation of the point cloud data and of motion across the sequence of the plurality of point clouds is thereafter determined based on the first and second sets of patches and the second point cloud. A scene flow representing the motion depicted across the sequence of the plurality of point clouds is then determined based on the latent representation.

In an additional aspect of the disclosure, a non-transitory computer-readable medium stores instructions that, when executed by a processor, cause the processor to perform operations. The operations include receiving point cloud data including a sequence of a plurality of point clouds with respect to time. The sequence of the plurality of point clouds includes a first point cloud and a second point cloud. The operations further include determining, for the first point cloud, a first set of patches. Each patch of the first set of patches is of a first size and associated with a respective portion of the first point cloud The operations further include determining, for the first point cloud, a second set of patches. Each patch of the second set of patches is of a second size different than the first size and associated with a respective portion of the first point cloud. A latent representation of the point cloud data and of motion across the sequence of the plurality of point clouds is thereafter determined based on the first and second sets of patches and the second point cloud. A scene flow representing the motion depicted across the sequence of the plurality of point clouds is then determined based on the latent representation.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2 ). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating a system for determining a scene flow according to one or more aspects of the disclosure.

FIG. 5 is a block diagram of an example machine learning (ML) model represented by an artificial neural network (ANN) according to one or more aspects of the disclosure.

FIG. 6 is a flow diagram illustrating an example pipeline for determining a scene flow according to one or more aspects of the disclosure.

FIG. 7 is a flow chart illustrating an example method for determining a scene flow according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support determining a scene flow from point cloud data representing a scene. The scene flow may alternatively be determined using image depth data representing the scene. Example embodiments include dividing point cloud data of video frames into patches of a first size and into patches of a second size. Further divisions of the point cloud data into other patches sizes beyond the two different patch sizes can be performed in some examples. A latent representation of the point cloud data and of motion in the point cloud data is determined based on the patches of the first and second sizes. For example, determining the latent representation includes providing the patches of the first size to a first self-attention mechanism and providing the patches of the second size to a second self-attention mechanism. In this example, each of the first and second self-attention mechanisms is a head in a multi-head attention mechanism that outputs the latent representation. In image processing, a latent representation refers to a compressed form of data that captures the essential features and underlying structure of an image (or point cloud) while discarding irrelevant information.

The scene flow can be determined in these example embodiments based on the latent representation. For example, the latent representation may be provided to a neural ODE machine learning model that outputs the scene flow. In some examples, creation of the scene flow involves adaptive sampling techniques that sample portions of the latent representation at sampling rates dependent upon the level of motion in the portions of the scene represented by the sampled portions. For example, a portion of the latent representation associated with a portion of the scene that includes fast motion (e.g., a car moving quickly across the scene) is sampled at a higher sampling rate than a portion of the latent representation associated with a portion of the scene that includes little to no motion. The adaptive sampling techniques can help manage computational resources efficiently. In various examples, a multi-frame attention mechanism operates across multiple frames when determining the scene flow, which enables the provided methods to capture long-range temporal dependencies in the point cloud data.

Example embodiments herein include separating flow features of the scene flow at particular time points into interpretable components. For example, scene flow may be disintegrated into global scene flow, which indicates scene flow for the whole scene, and local scene flow, which indicates scene flow for each point or group of points in the scene. For example, flow features may be separated into a rigid-body motion component that captures object-level motion in the scene and a non-rigid deformation component that captures local deformations and complex object interactions.

Particular implementations of the subject matter described in this disclosure may be implemented to realize one or more of the following potential advantages or benefits. In some aspects, the present disclosure provides techniques for image processing that may be particularly beneficial in smart vehicle applications. For example, the proposed techniques produce continuous scene flows with temporal coherence between discrete input video frames. Scene flows may be produced at variable frame rates, including a frame rate higher than an input frame rate. The scene flows may simultaneously capture both fine-grained local motion and global motion patterns. And the techniques may dynamically allocate computational resources based on motion complexity. In particular, the proposed techniques may enable more accurate tracking of the movement of vehicles, pedestrians, obstacles, road signage, road markings, and the like.

One benefit of improved tracking is that it allows vehicle control systems to more accurately navigate vehicles around obstacles. This can be particularly useful in situations where there may be unexpected obstructions or road conditions that could pose a hazard to drivers. Additionally, improved tracking can help to improve overall safety on the roads by reducing vehicle collisions. With better tracking capabilities, vehicles can be made more responsive to nearby obstacles and can be routed around detected obstacles more efficiently. These improvements can also extend to driver assistance systems, which can benefit from increased monitoring capabilities. By improving the detection of motion, these systems can offer more accurate alerts and assistance to drivers when necessary, without generating unnecessary notifications or distractions.

Another benefit of the proposed techniques is that flow features of the scene flow may be separated into interpretable components. These components provide human users with insights into scene dynamics and enable targeted analysis of specific motion types. The components also improve performance of downstream tasks, such as object tracking or three-dimensional reconstruction, and enhance interpretability of the scene flow for real-world applications such as autonomous driving or robotics.

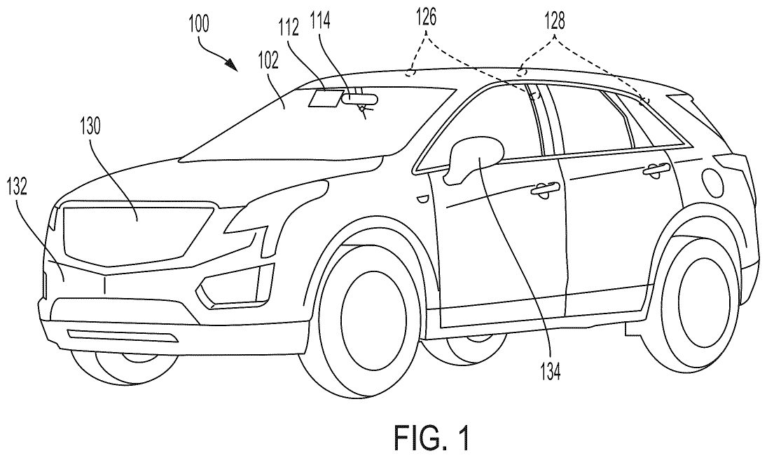

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

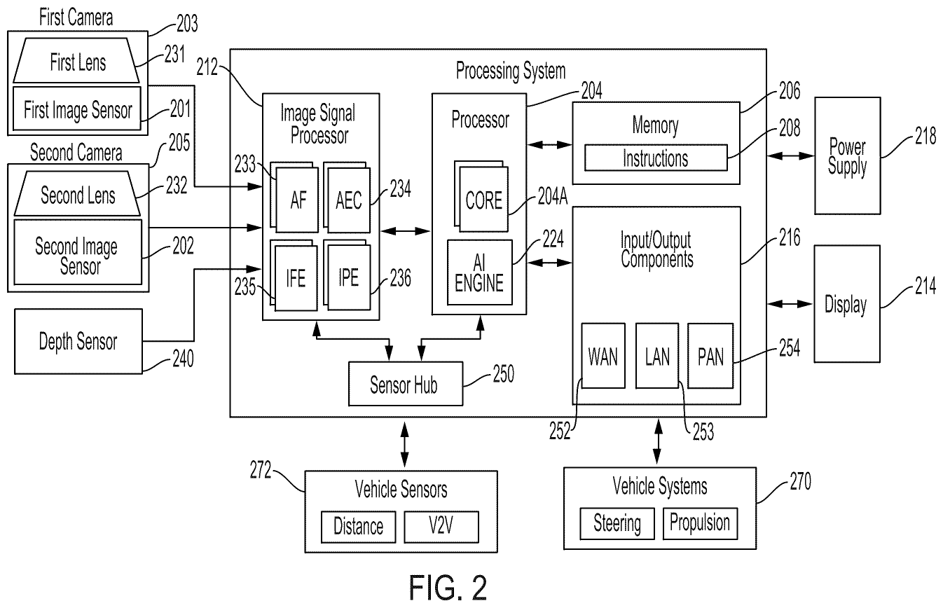

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

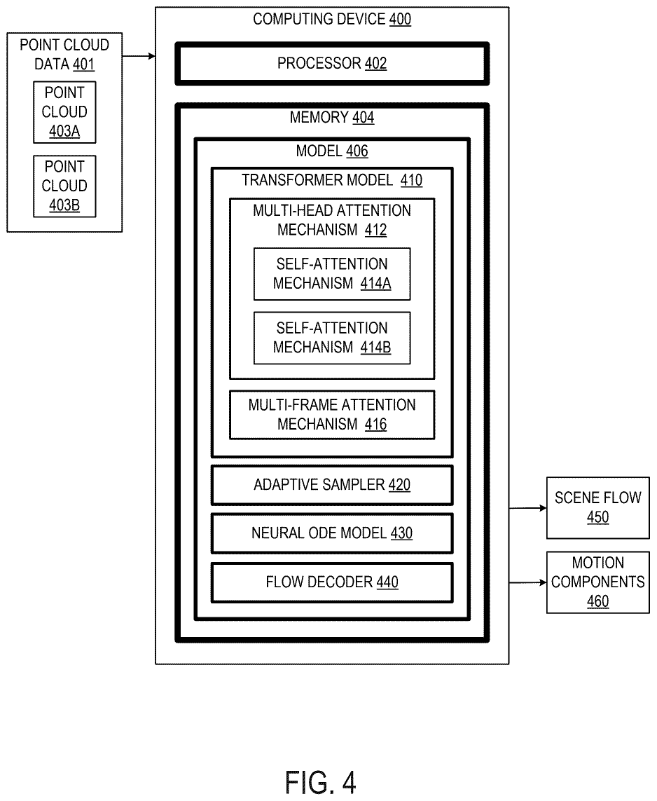

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination). The accuracy of the output of commands to the vehicle systems 270 may be improved according to embodiments of this disclosure by using one or more machine learning models, such as that described in connection with FIGS. 4 to 6, to determine scene flows of an environment around vehicle 100 that can affect the commands sent to the vehicle systems 270.

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

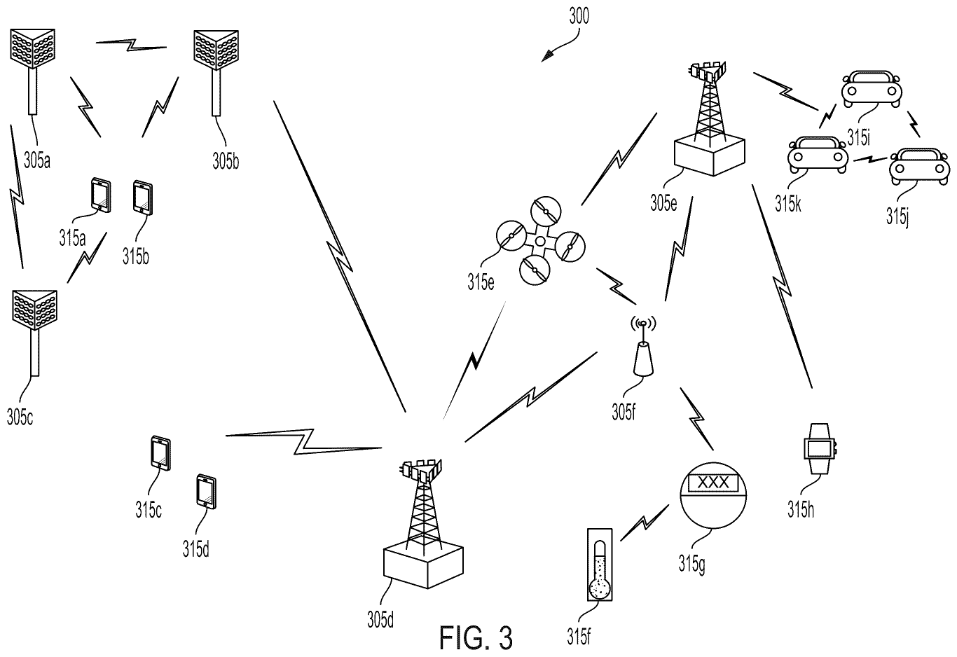

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports communications with ultra-reliable and redundant links for certain devices. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

Aspects of the vehicular systems described with reference to, and shown in, FIG. 1, FIG. 2, and FIG. 3 may include a machine learning model, such as a neural network, designed to output a continuous scene flow from a temporal sequence of video frames (e.g., point clouds) as input. The machine learning model divides the video frames into different sets of patches with each set including a particular size of patches. The machine learning model further utilizes respective self-attention mechanisms for each patch set, with each respective self-attention mechanism being a head in a multi-head attention mechanism. A latent representation of the video frames and of motion across the video frames is determined from the patch sets. In some embodiments, the machine learning model further utilizes a multi-frame attention mechanism for each patch set when determining the latent representation.

The machine learning model determines a continuous function that represents the scene flow based on the latent representation. For example, the machine learning model may include a neural ordinary differential equations (ODE) machine learning model that outputs the scene flow based on the latent representation as an input. In some embodiments, the machine learning model adaptively samples the latent representation when determining the scene flow based on the motion present in portions of the scene that is represented by the latent representation.

In some embodiments, the machine learning model includes a decoder that separates flow features of the scene flow at particular time points in the scene flow into different components of motion. For example, the decoder may separate flow features into a global component and a local component. For example, the decoder may separate flow features into a rigid body motion component and a non-rigid deformation component. In some embodiments, these motion components may be interpretable by human users.

FIG. 4 is a block diagram illustrating an example computing device 400. Computing device 400 receives as input point cloud data 401 and outputs a scene flow 450. In some embodiments, computing device 400 may additionally or alternatively output one or more motion components 460. Point cloud data 401 represents a scene around a vehicle and is a sequence of at least two point clouds of video frames captured by one or more cameras over a course of time. For example, point cloud data 401 may include a point cloud 403A and a point cloud 403B that proceeds point cloud 403A in time. For example, a camera on a vehicle may capture a series of video frames over time as the vehicle drives through an environment. Computing device 400 may be implemented by the image processing configuration of FIG. 2 or by one or more of the components illustrated in FIG. 3.

Computing device 400 includes a processor 402 (e.g., processor 204) coupled to a memory 404 (e.g., memory 206). In various aspects, processor 402 may include more than one processor. For example, processor 402 may include a first processor 402A (not shown) and a second processor 402B (not shown) that are each coupled to the memory 404. The first processor 402A may be in communication with the second processor 402B. The first processor 402A and the second processor 402B may each perform all of the operations performed by processor 402, or alternatively, the first processor 402A may only perform a first portion of the operations and the second processor 402B may only perform a second portion of the operations.

In various aspects, memory 404 may include more than one memory. For example, memory 404 may include a first memory 404A (not shown) and a second memory 404B (not shown) that are each coupled to processor 402. The first memory 404A and the second memory 404B may each store all of the processor-executable code for all of the operations of processor 402, or alternatively, the first memory 404A may only store a first portion of the processor-executable code and the second memory 404B may only store a second portion of the processor-executable code. In another example, processor 402 may include the first processor 402A and the second processor 402B that are each coupled to a first memory 404A (not shown) and a second memory 404B (not shown) of memory 404. In another example, processor 402 may include the first processor 402A coupled to the first memory 404A of memory 404, but not to the second memory 404B of memory 404, and the second processor 402B coupled to the second memory 404B, but not to the first memory 404B.

In aspects in which processor 402 includes two or more processors, the two or more processors may be included with the same computing device 400, or may be suitably separated among two or more computing devices 400. In aspects in which memory 404 includes two or more memories, the two or more memories may be included with the same computing device 400, or may be suitably separated among two or more computing devices 400. The computing device(s) 400 with which the two or more memories of memory 404 are included may be the same computing device(s) 400 with which the at least one processor of processor 402 is included or may be different. For example, a processor 402 may be included with a first computing device 400A (not shown) and a memory 404 may be included with a second computing device 400B (not shown), e.g., a server, in communication with the first computing device 400A over a network.

The at least one memory 404 stores a model 406. Model 406 is trained to output a continuous scene flow. In this way, model 406 predicts motion of objects in an environment surrounding a vehicle. In some embodiments, model 406 is trained to output components of motion captured in the continuous scene flow. Model 406 may be implemented as one or more machine learning models, including supervised learning models, unsupervised learning models, other types of machine learning models, and/or other types of predictive models. For example, model 406 may be implemented as one or more of a neural network, a transformer model, a decision tree model, a support vector machine, a Bayesian network, a classifier model, a regression model, and the like.

In various embodiments, model 406 includes a transformer model 410 trained to output a latent representation of point cloud data 401 and of motion across point clouds of point cloud data 401. For example, model 406 may be a neural network and transformer model 406 may be a layer of the neural network. Transformer model 410 may include a multi-head attention mechanism 412. Multi-head attention mechanism 412 may include a self-attention mechanism 414A as a first head and a self-attention mechanism 414B as a second head. In some examples, multi-head attention mechanism 412 may include more than two heads. In at least some embodiments, transformer model 410 may include a multi-frame attention mechanism 416. Transformer model 410 may be implemented as one or more machine learning models, including supervised learning models, unsupervised learning models, other types of machine learning models, and/or other types of predictive models. For example, transformer model 410 may be implemented as one or more of a neural network, a transformer model, a decision tree model, a support vector machine, a Bayesian network, a classifier model, a regression model, and the like.

In some embodiments, model 406 may include an adaptive sampler 420. For example, adaptive sampler 420 may be a layer in a neural network implementing model 406. Adaptive sampler 420 is an attention-based controller that determines optimal points and times at which to compute flow estimates, for determining scene flow 450, based on the complexity of motion in the scene. Stated differently, adaptive sampler 420 operates like an attention mechanism for temporal sampling.

In some embodiments, model 406 includes a neural ODE model 430 trained to output a continuous function representing the continuous scene flow. For example, model 406 may be a neural network and neural ODE model 430 may be a layer of the neural network. Neural ODE model 430 may be implemented as one or more machine learning models, including supervised learning models, unsupervised learning models, other types of machine learning models, and/or other types of predictive models. For example, neural ODE model 430 may be implemented as a neural network. For example, the neural network may be a neural ODE deep neural network model. For example, in neural ODE model 430, the transformation of data may be defined by a continuous-time dynamical system, rather than a discrete sequence of layers. Neural ODE model 430 may include loss function informed by physics to incorporate constraints such as conservation of mass and momentum during training of neural ODE model 430.

In some embodiments, model 406 may include a flow decoder 440. For example, flow decoder 440 may be a layer in a neural network implementing model 406. Flow decoder 440 may be a decoder network that breaks down scene flow 450 into separate channels for different components of motion.

Model 406 may be trained based on training data to determine the continuous scene flow, and in some embodiments, the motion components. For example, model 406 may be trained end-to-end on one or more training datasets that contain sets of temporally sequential point clouds of video frames depicting motion of one or more objects across time. In another example, the one or more training data sets may contain scene flow features including different motion components. The training data sets may specify one or more expected outputs. For example, flow vectors, flow features, or motion components. Parameters of model 406 may be updated based on whether model 406 generates correct outputs when compared to the expected outputs. In particular, model 406 may receive one or more pieces of input data from the training data sets that are associated with a plurality of expected outputs. Model 406 may generate predicted outputs based on a current configuration of model 406. The predicted outputs may be compared to the expected outputs and one or more parameter updates may be computed based on differences between the predicted outputs and the expected outputs. In particular, the parameters may include weights (e.g., priorities) for different features and combinations of features (e.g., position information of points in point clouds, positional differences between sequential point clouds in time, temporal information associated with point clouds, or velocity vectors). The parameter updates to model 406 may include updating one or more of the features analyzed and/or the weights assigned to different features or combinations of features (e.g., relative to the current configuration of model 406).

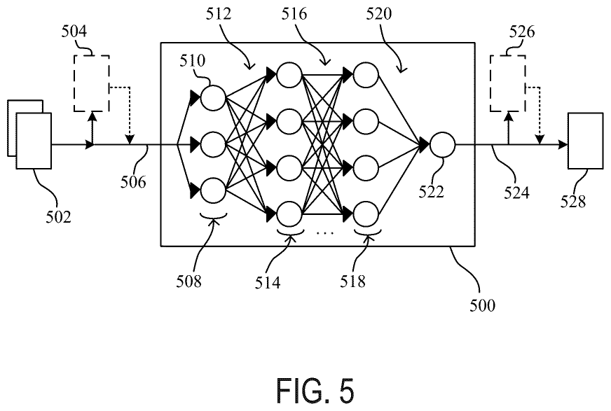

FIG. 5 is an illustrative block diagram of an example machine learning (ML) model, that may be implemented as model 406, transformer model 410, or neural ODE model 430, represented by an artificial neural network (ANN) 500. ANN 500 may receive input data 506 which may include one or more bits of data 502, pre-processed data output from pre-processor 504 (optional), or some combination thereof. Here, data 502 may include training data, verification data, application-related data, or the like, e.g., depending on the stage of deployment of ANN 500. Pre-processor 504 may be included within ANN 500 in some other implementations. Pre-processor 504 may, for example, process all or a portion of data 502 which may result in some of data 502 being changed, replaced, deleted, etc. In some implementations, pre-processor 504 may add additional data to data 502. In some implementations, the pre-processor 504 may be a ML model, such as an ANN.

ANN 500 includes at least one first layer 508 of artificial neurons 510 to process input data 506 and provide resulting first layer data via edges 512 to at least a portion of at least one second layer 514. Second layer 514 processes data received via edges 512 and provides second layer output data via edges 516 to at least a portion of at least one third layer 518. Third layer 518 processes data received via edges 516 and provides third layer output data via edges 520 to at least a portion of a final layer 522 including one or more neurons to provide output data 524. All or part of output data 524 may be further processed in some manner by (optional) post-processor 526. Thus, in certain examples, ANN 500 may provide output data 528 that is based on output data 524, post-processed data output from post-processor 526, or some combination thereof. Post-processor 526 may be included within ANN 500 in some other implementations. Post-processor 526 may, for example, process all or a portion of output data 524 which may result in output data 528 being different, at least in part, to output data 524, e.g., as result of data being changed, replaced, deleted, etc. In some implementations, post-processor 526 may be configured to add additional data to output data 524. In this example, second layer 514 and third layer 518 represent intermediate or hidden layers that may be arranged in a hierarchical or other like structure. Although not explicitly shown, there may be one or more further intermediate layers between the second layer 514 and the third layer 518. In some implementations, the post-processor 526 may be a ML model, such as an ANN.

The structure and training of artificial neurons 510 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process or during operation of the ML model. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the configuration for the ML model to change in response to identifying complex patterns and relationships in the input data 506 and determinations that should be made when those complex patterns and relationships are identified in the input data. Some non-exhaustive example activation functions include a sigmoid based activation function, a hyperbolic tangent (tanh) based activation function, a convolutional activation function, up-sampling, pooling, and a rectified linear unit (ReLU) based activation function.

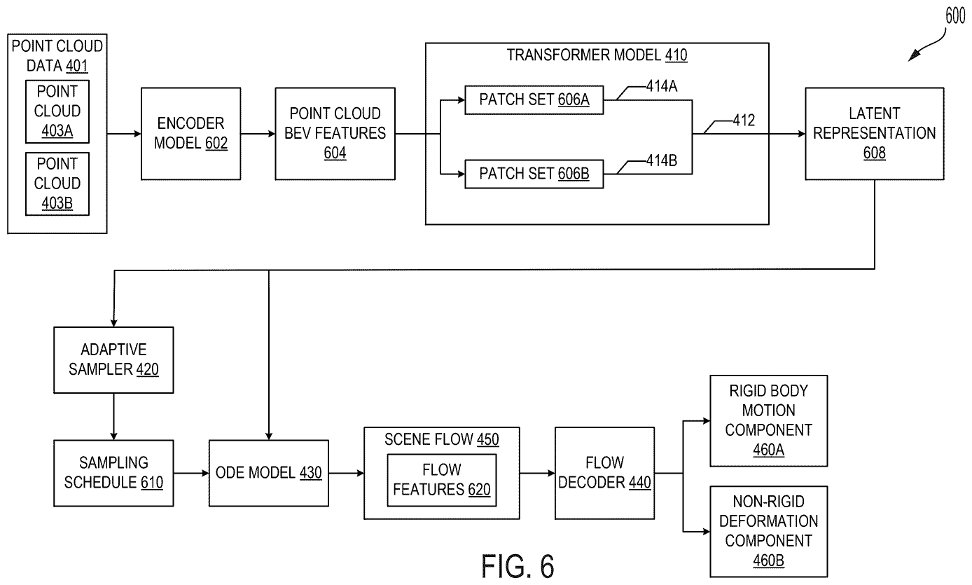

FIG. 6 is a flow diagram of an example pipeline 600 for determining a continuous scene flow, and in some embodiments, interpretable motion components. Shown in pipeline 600 are components of model 406, as well as inputs and outputs of the respective components. Pipeline 600 includes an encoder model 602 that extracts bird's-eye-view (BEV) features 604 from point cloud 403A and from point cloud 403B. BEV features 604 of point cloud 403A and of point cloud 403B are input to transformer model 410. Transformer model 410 processes, in some embodiments simultaneously, BEV features 604 of point cloud 403A at multiple scales. For example, transformer model 410 divides BEV features 604 of point cloud 403A into patches of a first size (e.g., 4×4) that form a first patch set 606A. Transformer model 410 also divides BEV features 604 of point cloud 403A into patches of a second size (e.g., 8×8) that form a second patch set 606B. While not depicted in FIG. 6, in some embodiments, transformer model 410 may generate more than two patch sets, such as by dividing BEV features 604 of point cloud 403A into a third patch set including patches of a third size (e.g., 16×16). Transformer model 410 processes BEV features 604 of point cloud 403B in a similar manner and thus the above description applies similarly to BEV features 604 of point cloud 403B.

Transformer model 410 then processes patch sets 606A, 606B (e.g., scales) of BEV features 604 of point cloud 403A by multi-head attention mechanism 412, which includes a dedicated self-attention mechanism for each patch set 606A and 606B. For example, patch set 606A may be processed by self-attention mechanism 414A, and patch set 606B may be processed by self-attention mechanism 414B. The input data (queries, keys, and values) to multi-head attention mechanism 412 is linearly projected into different subspaces for each respective self-attention mechanism 414A, 414B. Each self-attention mechanism 414A, 414B then performs attention independently to produce a set of outputs. Transformer model 410 similarly processes patch sets 606A, 606B (e.g., scales) of BEV features 604 of point cloud 403B to produce a set of outputs.

Multi-head attention mechanism 412 concatenates the outputs from each self-attention mechanism 414A, 414B for each point cloud 403A, 403B and linearly transforms the concatenated output to determine a latent representation 608 of point cloud 403A, of point cloud 403B, and of motion between point clouds 403A and 403B. The latent representation 608 is output by transformer model 410.

Multi-head attention mechanism 412 allows information to flow between the different scales of patch set 606A and patch set 606B of each of BEV features 604 of point cloud 403A and BEV features 604 of point cloud 403B. In this way, multi-head attention mechanism 412 enables transformer model 410 to simultaneously capture fine-grained local motion (e.g., smaller-sized patches) and overarching global motion patterns (e.g., larger-sized patches) in latent representation 608.

In at least some embodiments, transformer model 410 further includes multi-frame attention mechanism 416 that operates on the patch sets 606A, 606B associated with each of point cloud 403A and point cloud 403B, respectively. Multi-frame attention mechanism 416 extends the attention capabilities of transformer model 410 to work across multiple video frames. By utilizing both past and future video frames for context, and implementing both causal and non-causal attention modes, multi-frame attention mechanism 416 enables transformer model 410 to capture long-range temporal dependencies in latent representation 608, which improves flow consistency of the scene flow over time. In image processing, causal attention only considers past and present frames when making predictions, but does not have access to future frames, whereas non-causal attention can attend to past, present, and future frames, which allows transformer model 410 to use the entire sequence of point cloud data 401 for making predictions.

Latent representation 608 is thereafter used to determine scene flow 450 of the scene. In at least some embodiments, latent representation 608 is input to neural ODE model 430. Neural ODE model 430 processes latent representation 608 and outputs a continuous function of time and state that represents scene flow 450. The state vector encodes scene information (e.g., an x, y, z point in point cloud 403A or 403B) at any given time and is integrated into the continuous function to model the flow continuously. In this way, the output scene flow 450 may be a smooth, physically consistent flow interpolation with temporal continuity between video frames.

In some embodiments, latent representation 608 may be input to adaptive sampler 420 which determines the local motion complexity across the scene associated with latent representation 608. Based on the local motion complexity in various portions of the scene, adaptive sampler 420 determines a sampling rate needed for each portion. The more complex the motion, the higher the sampling rate and the more frequent the flow updates compared to a static portion without motion. In this way, adaptive sampler 420 allocates computational resources efficiently by focusing such resources were needed most. Specifically, adaptive sampler 420 efficiently allocates computational resources by increasing computational resources when needed for complex motion and decreasing when not for static or low complexity regions, rather than processing all points in latent representation 608 uniformly. Adaptive sampler 420 outputs a sampling schedule 610 that indicates times and points to compute flow estimates when determining scene flow 450.

In these embodiments with adaptive sampler 420, latent representation 608 is input to neural ODE model 430 along with sampling schedule 610. Neural ODE model 430 processes latent representation 608 according to sampling schedule 610 and outputs the continuous function of time and state that represents scene flow 450.

The continuous nature of scene flow 450 output from neural ODE model 430 allows for flow estimation (e.g., sampling) at arbitrary time points. For example, flow features 620 at a particular time point may be determined from scene flow 450. Flow features 620 may be indicative of information associated with motion in the scene at the particular time point. For example, a flow feature 620 may be an embedding that indicates a number of points and a dimension for the particular time point in scene flow 450.

In some embodiments, flow features 620 may be input to flow decoder 440 that decodes flow features 620 into one or more separate interpretable motion components 460. Motion components 460, as used herein, are components of the overall motion in the scene represented by flow features 620. For example, flow features 620 may be disintegrated into a global scene flow component, which indicates scene flow for the whole scene, and a local scene flow component, which indicates scene flow for each point or group of points in the scene. The decoder network of flow decoder 440 includes parallel branches (e.g., channels) for each motion component 460 that is to be determined. For example, in the depicted embodiment, the decoder network includes a first branch that determines a rigid body motion component 460A (e.g., global scene flow component) and a second branch that determines a non-rigid deformation component 460 (e.g., local scene flow component). In some examples, the decoder network may include regularization to encourage sparsity in non-rigid deformation. In some examples, the decoder network may include consistency loss so that the one or more motion components 460 sum to the total estimated flow in scene flow 450.

The rigid body motion component 460A represents object-level motion in the scene and is applied to points relative to a center of an object. Stated differently, rigid body motion component 460A represents motion for the whole point cloud sequence. In an example, rigid body motion component 460A may be represented by a rotation matrix and a translation vector. In some examples, the branch associated with rigid body motion component 460B may be modeled using a multi-layer perceptron or linear layers. The non-rigid deformation component 460B represents local deformations and complex object interactions. Stated differently, non-rigid deformation component 460B represents motion for each point in the point cloud sequence. In some examples, the branch associated with non-rigid deformation component 460B may be modeled using a multi-layer perceptron or linear layers. In these examples, the multi-layer perceptron or linear layers take point coordinates and time as input.

Decoding flow features 620 into separate, interpretable motion components 460 can improve performance of tasks such as object tracking, 3D reconstruction, and motion analysis. The motion components 460 can further enable human users to uncover insights into scene dynamics, or to perform targeted analysis of specific motion types, all within the context of real-world applications such as autonomous driving or robotics.

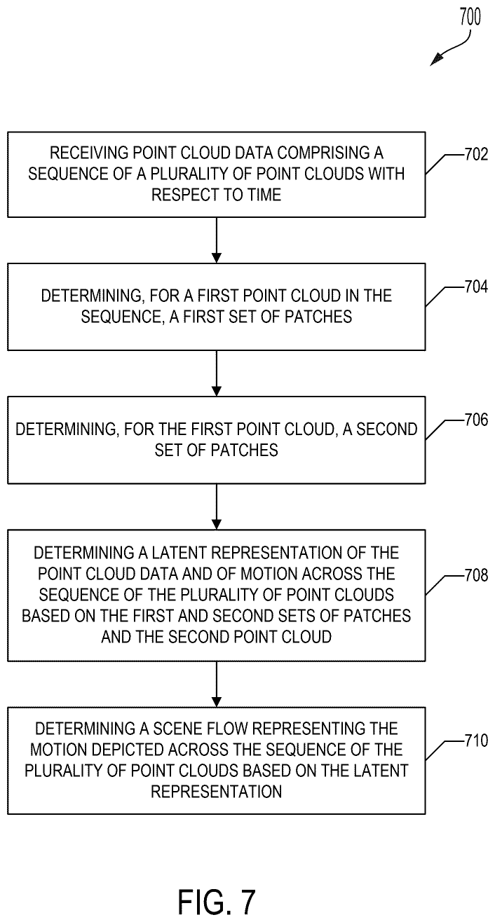

One method of performing image processing according to embodiments described above is shown in FIG. 7. FIG. 7 is a flow chart illustrating an example method 700 for determining a scene flow. Method 700 includes, at block 702, receiving point cloud data (e.g., point cloud data 401) comprising a sequence of a plurality of point clouds (e.g., point clouds 403A, 403B) with respect to time. The sequence includes a first point cloud (e.g., point cloud 403A) and a second point cloud (e.g., point cloud 403B).

At block 704, a first set of patches (e.g., patch set 606A) is determined for point cloud 403A. Each patch of patch set 606A is of a first size (e.g., 8×8) and includes a respective portion of point cloud 403A.

At block 706, a second set of patches (e.g., patch set 606B) is determined for point cloud 403A. Each patch of the patch set 606B is of a second size (e.g., 16×16) different than the first size and includes a respective portion of point cloud 403A.

At block 708, a latent representation (e.g., latent representation 608) of the point cloud data 401 and of motion across the sequence of the plurality of point clouds 403A, 403B is determined based on patch set 606A, patch set 606B, and point cloud 403B. In some embodiments, latent representation 608 is determined based on patch set 606A and patch set 606B based on a multi-head attention mechanism (e.g., multi-head attention mechanism 412). In such embodiments, multi-head attention mechanism 412 may include a first self-attention mechanism (e.g., self-attention mechanism 414A) and a second self-attention mechanism (e.g., self-attention mechanism 414B). Patch set 606A may be provided to self-attention mechanism 414A that linearly transforms patch set 606A into a first output based on the first size. Patch set 606B may be provided to self-attention mechanism 414B that linearly transforms patch set 606B into a second output based on the second size. In these embodiments, determining latent representation 608 may include concatenating the first output and the second output. In some embodiments, latent representation 608 is determined based on multi-frame attention with respect to the sequence of the plurality of point clouds 403A, 403B.

At block 710, a scene flow (e.g., scene flow 450) representing the motion depicted across the sequence of the plurality of point clouds 403A, 403B is determined based on latent representation 608. In some embodiments, determining scene flow 450 includes providing latent representation 608 to a neural ordinary differential equations machine learning model (e.g., neural ODE model 430) which thereafter outputs scene flow 450. In some embodiments, determining scene flow 450 based on latent representation 608 includes sampling a first portion of latent representation 608 at a first sampling rate and sampling a second portion of latent representation 608 at a second sampling rate different than the first sampling rate. In an example, the first portion has greater motion than the second portion and the first sampling rate is greater than the second sampling rate.

In some embodiments, method 700 may further include determining a third set of patches (e.g., a second patch set 606A), and a fourth set of patches (e.g., a second patch set 606B) for point cloud 403B. Each patch of the third patch set 606A is of the first size and includes a respective portion of point cloud 403B. Each patch of the second patch set 606B is of the second size and includes a respective portion of point cloud 403B. In these embodiments, determining latent representation 608 is based on patch sets 606A and 606B of point cloud 403A, and patch sets 606A and 606B of point cloud 403B.

In some embodiments, method 700 may further include determining one or more components (e.g., motion components 460) of the motion at a time point in scene flow 450. For example, method 700 may include determining a rigid body motion component 460A and a non-rigid deformation component 460B associated with scene flow 450. Determining the one or more motion components 460 may include determining flow information (e.g., flow features 620) at the time point in scene flow 450. In this case, the one or more motion components 460 may be decoded from flow features 620.

In some aspects, method 700 may further include controlling a function of vehicle 100 based on scene flow 450. For example, scene flow 450 may be input to a driving assistance system that processes scene flow 450 to control functions of the vehicle 100. In some aspects, method 700 may further include controlling a function of vehicle 100 based on the one or more motion components 460. For example, the one or more motion components 460 may be input to a driving assistance system that processes the one or more motion components 460 to control functions of the vehicle 100.

It is noted that one or more blocks (or operations) described with reference to FIG. 7 may be combined with one or more blocks (or operations) described with reference to another of the figures. For example, one or more blocks (or operations) of FIG. 7 may be combined with one or more blocks (or operations) of FIG. 1-3. As another example, one or more blocks associated with FIG. 7 may be combined with one or more blocks associated with FIG. 4 or 6.

In one or more aspects, techniques for supporting vehicular operations may include additional aspects, such as any single aspect or any combination of aspects described below or in connection with one or more other processes or devices described elsewhere herein. In a first aspect, an apparatus is configured to perform operations including receiving point cloud data including a sequence of a plurality of point clouds with respect to time. The sequence of the plurality of point clouds includes a first point cloud and a second point cloud. The method further includes determining, for the first point cloud, a first set of patches. Each patch of the first set of patches is of a first size and associated with a respective portion of the first point cloud The method further includes determining, for the first point cloud, a second set of patches. Each patch of the second set of patches is of a second size different than the first size and associated with a respective portion of the first point cloud. A latent representation of the point cloud data and of motion across the sequence of the plurality of point clouds is thereafter determined based on the first and second sets of patches and the second point cloud. A scene flow representing the motion depicted across the sequence of the plurality of point clouds is then determined based on the latent representation.

In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the operations further include determining, for the second point cloud, a third set of patches. Each patch of the third set of patches is of the first size and associated with a respective portion of the second point cloud. In the second aspect, the operations further include determining, for the second point cloud, a fourth set of patches, wherein each patch of the fourth set of patches is of the second size and associated with a respective portion of the fourth point cloud. In this aspect, determining the latent representation is based on the first, second, third, and fourth sets of patches.

In a third aspect, in combination with one or more of the first aspect or the second aspect, determining the scene flow includes providing the latent representation to a neural ordinary differential equations machine learning model which thereafter outputs the scene flow.

In a fourth aspect, in combination with one or more of the first aspect through the third aspect, the latent representation is determined from the first set of patches and the second set of patches based on a multi-head attention mechanism.

In a fifth aspect, in combination with the fourth aspect, the multi-head attention mechanism includes a first self-attention mechanism and a second self-attention mechanism, and determining the latent representation includes: providing the first set of patches to the first self-attention mechanism that linearly transforms the first set of patches into a first output based on the first size, providing the second set of patches to the second self-attention mechanism that linearly transforms the second set of patches into a second output based on the second size, and concatenating the first output and the second output.

In a sixth aspect, in combination with one or more of the first aspect through the fifth aspect, determining the scene flow based on the latent representation includes sampling a first portion of the latent representation at a first sampling rate and sampling a second portion of the latent representation at a second sampling rate different than the first sampling rate.

In a seventh aspect, in combination with the sixth aspect, the first portion has greater motion than the second portion and the first sampling rate is greater than the second sampling rate.

In an eighth aspect, in combination with one or more of the first aspect through the seventh aspect, the operations further include determining one or more components of the motion at a time point in the scene flow.

In a ninth aspect, in combination with the eighth aspect, the operations further include controlling a function of a vehicle based on the one or more components.

In a tenth aspect, in combination with one or more of the first aspect through the ninth aspect, the latent representation is determined based on multi-frame attention with respect to the sequence of the plurality of point clouds.

In an eleventh aspect, in combination with one or more of the first aspect through the eighth aspect and the tenth aspect, the operations further include controlling a function of a vehicle based on the scene flow.

Components, the functional blocks, and the modules described herein with respect to FIGS. 1-4 and 6 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for image processing, comprising:
receiving point cloud data comprising a sequence of a plurality of point clouds with respect to time, wherein the sequence of the plurality of point clouds includes a first point cloud and a second point cloud;
determining, for the first point cloud, a first set of patches, wherein each patch of the first set of patches is of a first size and associated with a respective portion of the first point cloud;
determining, for the first point cloud, a second set of patches, wherein each patch of the second set of patches is of a second size different than the first size and associated with a respective portion of the first point cloud;
determining a latent representation of the point cloud data and of motion across the sequence of the plurality of point clouds based on the first and second sets of patches and the second point cloud; and
determining a scene flow representing the motion depicted across the sequence of the plurality of point clouds based on the latent representation.

2. The method of claim 1, further comprising:
determining, for the second point cloud, a third set of patches, wherein each patch of the third set of patches is of the first size and associated with a respective portion of the second point cloud; and
determining, for the second point cloud, a fourth set of patches, wherein each patch of the fourth set of patches is of the second size and associated with a respective portion of the second point cloud,
wherein determining the latent representation is based on the first, second, third, and fourth sets of patches.

3. The method of claim 1, wherein determining the scene flow includes providing the latent representation to a neural ordinary differential equations machine learning model which thereafter outputs the scene flow.

4. The method of claim 1, wherein the latent representation is determined from the first set of patches and the second set of patches based on a multi-head attention mechanism.

5. The method of claim 4, wherein the multi-head attention mechanism includes a first self-attention mechanism and a second self-attention mechanism, and wherein determining the latent representation includes:
providing the first set of patches to the first self-attention mechanism that linearly transforms the first set of patches into a first output based on the first size,
providing the second set of patches to the second self-attention mechanism that linearly transforms the second set of patches into a second output based on the second size, and
concatenating the first output and the second output.

6. The method of claim 1, wherein determining the scene flow based on the latent representation includes sampling a first portion of the latent representation at a first sampling rate and sampling a second portion of the latent representation at a second sampling rate different than the first sampling rate.

7. The method of claim 1, further comprising determining one or more components of the motion at a time point in the scene flow.

8. The method of claim 1, wherein the latent representation is determined based on multi-frame attention with respect to the sequence of the plurality of point clouds.

9. An apparatus, comprising:
a memory storing processor-readable code; and
at least one processor coupled to the memory, the at least one processor configured to execute the processor-readable code to cause the at least one processor to perform operations including:
receiving point cloud data comprising a sequence of a plurality of point clouds with respect to time, wherein the sequence of the plurality of point clouds includes a first point cloud and a second point cloud;
determining, for the first point cloud, a first set of patches, wherein each patch of the first set of patches is of a first size and associated with a respective portion of the first point cloud;
determining, for the first point cloud, a second set of patches, wherein each patch of the second set of patches is of a second size different than the first size and associated with a respective portion of the first point cloud;
determining a latent representation of the point cloud data and of motion across the sequence of the plurality of point clouds based on the first and second sets of patches and the second point cloud; and
determining a scene flow representing the motion depicted across the sequence of the plurality of point clouds based on the latent representation.

10. The apparatus of claim 9, wherein the operations further include:
determining, for the second point cloud, a third set of patches, wherein each patch of the third set of patches is of the first size and associated with a respective portion of the second point cloud; and
determining, for the second point cloud, a fourth set of patches, wherein each patch of the fourth set of patches is of the second size and associated with a respective portion of the second point cloud,
wherein determining the latent representation is based on the first, second, third, and fourth sets of patches.

11. The apparatus of claim 9, wherein determining the scene flow includes providing the latent representation to a neural ordinary differential equations machine learning model which thereafter outputs the scene flow.

12. The apparatus of claim 9, wherein the latent representation is determined from the first set of patches and the second set of patches based on a multi-head attention mechanism.

13. The apparatus of claim 12, wherein the multi-head attention mechanism includes a first self-attention mechanism and a second self-attention mechanism, and wherein determining the latent representation includes:
providing the first set of patches to the first self-attention mechanism that linearly transforms the first set of patches into a first output based on the first size,
providing the second set of patches to the second self-attention mechanism that linearly transforms the second set of patches into a second output based on the second size, and
concatenating the first output and the second output.

14. The apparatus of claim 9, wherein determining the scene flow based on the latent representation includes sampling a first portion of the latent representation at a first sampling rate and sampling a second portion of the latent representation at a second sampling rate different than the first sampling rate.

15. The apparatus of claim 9, wherein the operations further include determining one or more components of the motion at a time point in the scene flow.

16. The apparatus of claim 9, wherein the latent representation is determined based on multi-frame attention with respect to the sequence of the plurality of point clouds.

17. A vehicle, comprising:
a ranging sensor;
a memory storing processor-readable code; and
at least one processor coupled to the memory, the at least one processor in communication with the ranging sensor and configured to execute the processor-readable code to cause the at least one processor to perform operations including:
receiving, from the ranging sensor, point cloud data comprising a sequence of a plurality of point clouds with respect to time, wherein the sequence of the plurality of point clouds includes a first point cloud and a second point cloud;
determining, for the first point cloud, a first set of patches, wherein each patch of the first set of patches is of a first size and associated with a respective portion of the first point cloud;
determining, for the first point cloud, a second set of patches, wherein each patch of the second set of patches is of a second size different than the first size and associated with a respective portion of the first point cloud;
determining a latent representation of the point cloud data and of motion across the sequence of the plurality of point clouds based on the first and second sets of patches and the second point cloud; and
determining a scene flow representing the motion depicted across the sequence of the plurality of point clouds based on the latent representation.

18. The vehicle of claim 17, wherein the operations further include controlling a function of the vehicle based on the scene flow.

19. The vehicle of claim 17, further comprising determining one or more components of the motion at a time point in the scene flow.

20. The vehicle of claim 19, wherein the operations further include controlling a function of the vehicle based on the one or more components of the motion.
